(19) United States
(12) Patent Application Publication
(10) Pub. No.: US 2014/0019151 A1
(43) Pub. Date: Jan. 16, 2014

(54) WELLNESS HEALTHCARE AND PERSONALIZED MEDICINE SYSTEM

(71) Applicant: Permesys, Inc., Bothell, WA (US)

(72) Inventors: Roger C. Adami, Bothell, WA (US); David P. Bowler, Naperville, IL (US)

(73) Assignee: Permesys, Inc., Bothell, WA (US)

(21) Appl. No.: 13/931,620

(22) Filed: Jun. 28, 2013

Related U.S. Application Data
(60) Provisional application No. 61/763,349, filed on Feb. 11, 2013.
(60) Provisional application No. 61/666,425, filed on Jun. 29, 2012.

(51) Int. Cl. G06F 19/00

(52) U.S. Cl. CPC G06F 19/345
USPC 705/2

(57) ABSTRACT

Methods, devices and systems for performing personalized wellness healthcare by forming a patient personal assessment using one or more bioindicator levels and one or more personal indicator communications. A processor assigns relational impact factors to the input, and a differentiator determines a diagnosis or prognosis based on normal and disease states. A treatment and/or wellness plan can be generated. The methods, devices and systems can be operated in a kiosk, and/or remotely.

### BACKGROUND OF THE INVENTION

By any measure, the cost of consumer health care has risen rapidly in recent years. In one point of view, the widespread availability and use of expensive clinical testing is partly to blame. In another view, numerous inefficiencies can be found in the way healthcare is practiced and delivered.

The practice of medicine today relies heavily on analytical and diagnostic tools that are used to characterize a condition or disease. Often, the use of analytical and diagnostic tools involves determination of bioindicator levels to point to a symptom or disease.

Moreover, the bioindicator data can suggest a general treatment plan because the advanced arts of pharmaceutical sciences and medicinal chemistry have identified drugs for many different conditions and diseases.

Drawbacks of the current practice of healthcare include inefficient use of the clinician's time in administering and monitoring a treatment plan. Other drawbacks include inefficient use of the clinician's time in gathering and analyzing bioindicator data to provide a diagnosis or prognosis.

One way to improve healthcare is to provide for wellness. To deliver wellness to subjects, information can be provided to the subjects so that they can take control of their personal healthcare needs. For example, wellness information can include details concerning preventative medicine, use of pharmaceuticals, diet and nutrition, exercise, or self-abusive behavior.

One drawback of wellness programs is that they are not personalized to take into account certain biomarkers of an individual subject. A further drawback is a general lack of monitoring a subject for changes in health or changes in various biomarker levels. Without these aspects, wellness programs can fail to allow a subject to take control of their personal healthcare needs.

What is needed are systems, devices and methods for efficiently obtaining subject healthcare data and health bioindicator level data for providing medical treatment plans and/or wellness to subjects so that they can take control of their personal healthcare needs. There is a continuing need for methods and devices to monitor a subject in a treatment plan, and to provide a diagnosis or prognosis, or to provide wellness healthcare to subjects.

### BRIEF SUMMARY OF THE INVENTION

This invention provides systems, devices and methods for delivery and management of health care and consumer-directed personalized medicine. The systems, devices and methods of this invention involve medical treatments and wellness aspects which are delivered directly to patients and subjects in need of improving health.

This disclosure relates to a system, devices and methods for creating a medical diagnosis and/or delivering wellness healthcare to a subject. The systems and methods of this invention can be used for processing patient personal data and communications to provide diagnosis or prognosis of a condition, disorder or disease.

Embodiments of this invention include:

A method for performing personalized wellness healthcare, the method comprising:

forming a patient personal assessment by operating a patient personalization processor for receiving input comprising one or more bioindicator levels and one or more patient personal indicator communications, wherein the processor assigns relational impact factors to the input, thereby providing a patient personal assessment;

operating a differentiator processor for determining a diagnosis or prognosis by determining differences between the patient personal assessment and normal and disease patient states;

generating a treatment and/or wellness plan based on the diagnosis or prognosis; and

displaying a visualization of the differences between the patient personal assessment and the normal and disease patient states, the diagnosis or prognosis, and the treatment and/or wellness plan.

The method above, wherein the disease is vitamin deficiency or vitamin D deficiency disease. The method above, wherein the bioindicators are genomic, proteomic, or clinical. The method above, wherein the personal indicators are habitual, corporeal, geographical, temporal, seasonal, or physical.

The method above, wherein the differences between the patient personal assessment and the normal and disease patient states are differentiating distances, or are determined by one or more of bioindicator T-scores, bioindicator Z-scores, Hamming distances based on patient personal indicators, and combinations thereof.

The method above, wherein the treatment and/or wellness plan is determined by one or more methods selected from ADME analysis, regression analysis, residual error prediction, and principal component analysis. The method above, wherein the treatment and/or wellness plan comprises providing a pharmaceutical, a nutraceutical, or a nutritional supplement.

A personalized wellness healthcare device for providing patient wellness, the device comprising:

a portal for input and communication among patients, providers and laboratories;

a patient personalization module processor for receiving input comprising one or more bioindicator levels and one or more patient personal indicator communications, wherein the patient personalization module processor assigns relational impact factors to the input, thereby providing a patient personal assessment;

a normal-patient module containing normal patient data representing a normal patient state;

a disease-patient module containing disease patient data representing a disease patient state;

a differentiator processor for determining a diagnosis or prognosis by determining differences between the patient personal assessment and the normal and disease patient states;

a treatment and/or wellness plan module for determining or adjusting a treatment and/or wellness plan based on the diagnosis or prognosis; and

a display for visualizing the differences between the patient personal assessment and the normal and disease patient states, the diagnosis or prognosis, and the treatment and/or wellness plan.

The device above, wherein the disease is vitamin deficiency or vitamin D deficiency disease. The device above, wherein the input is data comprising any one or more of bioindicator levels, current bioindicator levels, patient personal indicator communications, and current patient personal indicator communications. The device above, wherein the differences between the patient personal assessment and the normal and disease patient states include differences in vitamin D levels.

The device above, wherein the differences between the patient personal assessment and the normal and disease patient states are differentiating distances, or are determined from one or more of bioindicator T-scores, bioindicator Z-scores, Hamming distances, and combinations thereof.

The device above, wherein the treatment and/or wellness plan is determined by one or more methods selected from residual error prediction, ADME analysis, regression analysis, and principal component analysis.

A system for personalized wellness healthcare comprising the device above, wherein the portal is an internet portal accessible to providers who are clinicians and is interfaced to a fulfillment center. The system above, wherein the fulfillment center provides one or more products to patients according to the treatment and/or wellness plan. The system above, wherein the fulfillment center provides one or more products to the patient in a blister pack whose contents are tailored to the individual patient according to the treatment and/or wellness plan. The system above, wherein the fulfillment center provides to the patient a kit comprising a bioindicator home test and instructions to provide input through the internet portal. The system above, further comprising an electronic forum for social networking and communication among patients, providers and laboratories.

A nutritional supplement composition comprising 50 to 50,000 IU cholecalciferol, Vitamin K1, Vitamin K2, and one or more multi-nutrients. The composition above, wherein the multi-nutrients are selected from vitamin B1, vitamin B2, vitamin B6, vitamin B12, vitamin C, vitamin A, vitamin E, lycopene, lutein, folic acid, niacinamide, Coenzyme Q10, thiamine, riboflavin, biotin, pantothenic acid, polyunsaturated fatty acids, long chain polyunsaturated fatty acids, minerals, amino acids, carotenoids, docosahexaenoic acid, arachidonic acid, alpha-linolenic acid, alpha-carotene, beta-carotene, and mixtures thereof

The composition above, further comprising caffeine. The composition above, further comprising a probiotic or psyllium. The composition above, wherein the cholecalciferol is present in an amount from 10% to 12,000% of the daily recommended adult dosage. The composition above, wherein the composition is in the form of liquid drops, softgels, a chewable tablet or gum, a cream, tablets or powder.

A method for improving health comprising administering the composition above to a subject in need thereof. A method for improving health comprising administering the composition above to a subject in need thereof, and managing the dose according to a bioindicator. The method above, wherein the bioindicator is plasma 25(OH)D level.

A non-transitory tangible computer-readable medium having stored therein instructions for carrying out the steps of a method for performing personalized wellness healthcare, the method comprising:

forming a patient personal assessment by operating a patient personalization processor for receiving input comprising one or more bioindicator levels and one or more patient personal indicator communications, wherein the processor assigns relational impact factors to the input, thereby providing a patient personal assessment;

operating a differentiator processor for determining a diagnosis or prognosis by determining differences between the patient personal assessment and normal and disease patient states;

generating a treatment and/or wellness plan based on the diagnosis or prognosis; and

displaying a visualization of the differences between the patient personal assessment and the normal and disease patient states, the diagnosis or prognosis, and the treatment and/or wellness plan.

The non-transitory tangible computer-readable medium above, wherein the disease is vitamin deficiency or vitamin D deficiency disease. The non-transitory tangible computer-readable medium above, wherein the bioindicator levels are genomic, proteomic, and clinical. The non-transitory tangible computer-readable medium above, wherein the personal indicators are habitual, corporeal, geographical, temporal, seasonal, and physical. The non-transitory tangible computer-readable medium above, wherein the differences are differentiating distances, or are determined by one or more of bioindicator T-scores, bioindicator Z-scores, Hamming distances based on patient personal indicators, and combinations thereof. The non-transitory tangible computer-readable medium above, wherein the treatment and/or wellness plan is determined by one or more methods selected from residual error prediction, ADME analysis, regression analysis, and principal component analysis.

A method for providing wellness comprising:

collecting one or more results of a questionnaire from a subject;

determining a dose of a nutritional supplement based on the results of the questionnaire; and

providing the nutritional supplement to the subject in the determined dose.

The method above, wherein the questionnaire has questions concerning habitual, corporeal, geographical, temporal, seasonal, or physical personal indicators of the subject. The method above, wherein providing the nutritional supplement to the subject is performed by a fulfillment center or a brick and mortar station. The method above, wherein the nutritional supplement is a vitamin. The method above, wherein the nutritional supplement is vitamin D.

A method for providing wellness comprising:

collecting one or more results of a questionnaire from a subject;

collecting one or more bioindicator levels from a subject;

determining a dose of a nutritional supplement based on the results of the questionnaire and the bioindicator levels; and

providing the nutritional supplement to the subject in the determined dose.

The method above, wherein the questionnaire has questions concerning habitual, corporeal, geographical, temporal, seasonal, or physical personal indicators of the subject. The method above, wherein the bioindicator level is plasma 25(OH)D level. The method above, wherein providing the nutritional supplement to the subject is performed by a fulfillment center or a brick and mortar station. The method above, wherein the nutritional supplement is a vitamin. The method above, wherein the nutritional supplement is vitamin D.

In the following description, reference is made to the accompanying drawings that form a part hereof, and in which is shown by way of illustration specific embodiments which may be practiced. These embodiments are described in detail to enable those skilled in the art to practice the invention, and it is to be understood that other embodiments may be utilized and that various changes may be made without departing from the scope of the present invention. The following description of example embodiments is, therefore, not to be taken in a limited sense, or limited to any preferred embodiments, and the scope of the present invention is defined by the appended claims.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

FIG. 1 shows a schematic of a system for wellness healthcare and personalized medicine delivery including a diagnosis-prognosis device having one or more portals, a processor, a display, and modules for treatment and wellness plans, and normal and disease state modules. A portal can be an internet portal through which data and communications can be obtained or entered. A portal can also receive input from a brick and mortar station. Data is received and stored in a patient personalization module including patient personal health indicator communications and measured bioindicator levels that are assigned relational impact factors. The system includes a processor for determining a diagnosis or prognosis by differentiating between patient data and normal and disease states, as well as generating a treatment and/or wellness plan, which can be output to a display. The treatment and/or wellness plan can be linked to a product center and to a fulfillment center to provide products directly to a patient or subject according to the treatment plan. The diagnosis-prognosis device can be accessed securely by a clinician to facilitate or modify the treatment plan. Current patient data can be obtained and inputted to provide a prognosis. Feedback loops allow follow-on patient information to be obtained.

FIG. 2 shows a flowchart of operational features of a system for wellness healthcare and personalized medicine delivery that includes a diagnosis-prognosis device. Signals relaying patient bioindicator data and patient personal health indicator communications are received and stored in a patient personalization module. A processor receives input from the patient personalization module and processes the patient data with input from disease and normal modules to provide a diagnosis or prognosis. The diagnosis or prognosis is displayed along with a treatment and/or wellness plan and other details to be accessed by clinicians and subjects. The treatment plan is also received by a product center and fulfillment center to provide product to the patient. Requests can be made to obtain current or follow-on patient information in a feedback loop. The a feedback loop allows the system to monitor changes in patient biomarker levels and to modify the treatment and/or wellness plan so that a subject can take control of health and wellness. Among other things, a subject may take control to titrate biomarker levels into a normal range, or to bring a health or wellness criterion into a normal or wellness state.

FIG. 3 shows a schematic of an example of delivering health care by enabling a patient to monitor and balance biophysical processes for improving health. In this example, the amount of vitamin D produced by exposure to UV light varies substantially over time. Under a treatment plan of this disclosure, a patient can monitor and balance actual vitamin D levels using supplement levels determined by a diagnosis-prognosis device of this disclosure.

FIG. 4 shows a schematic of an example of delivering health care by enabling a patient to monitor and balance biophysical processes for improving health. In this example, the amount of vitamin D in a patient is titrated to a constant level over time which falls in a recommended range. The desired result can be achieved regardless of changes in behavior or changes in biological responses that cannot be predicted.

FIG. 5 shows a schematic of a skin type scale used for communications input to a system for vitamin D healthcare delivery including a diagnosis-prognosis device.

FIG. 6 shows a chart of the achievable levels of vitamin D using a healthcare delivery system including a diagnosis-prognosis device for a model group of patients whose members reflect a wide variation of unpredictable biological responses. The results show that for all but a few of the higher weight patients the amount of vitamin D that is provided within the patient's body over a twelve month period is at least 92% of the recommended annual need.

FIG. 7 shows a chart of the achievable levels of vitamin D using a healthcare delivery system including a diagnosis-prognosis device for a model group of patients whose members reflect a wide variation of unpredictable biological responses. The results show that the amount of vitamin D that is provided within the patient's body over a six month period is at least 82% of the recommended need.

FIG. 8 shows a chart of the achievable levels of vitamin D for a model group of patients whose members reflect a wide variation of unpredictable biological responses.

FIG. 9 shows a chart of the age factor used to adjust the dose of vitamin D.

### DETAILED DESCRIPTION OF THE INVENTION

This invention provides systems, devices and methods for delivery and management of consumer health care, wellness and consumer medicine. The systems, devices and methods of this invention traverse the fields of medicine, health care, and wellness by providing medical treatments and wellness aspects directly to patients and subjects in need of improving health. In some aspects, this invention provides systems, devices and methods for consumer-directed personalized medicine.

This invention relates to the fields of wellness healthcare, personalized medicine and medical diagnosis. In particular, this application relates to systems, devices and methods for creating and delivering a wellness healthcare prognosis and/or treatment plan, or a medical diagnosis and/or treatment plan, for personalized healthcare of a subject. More particularly, this application relates to systems, devices and methods for combining patient personal data and differentiating conditions for providing prognosis, diagnosis, treatment or wellness of a subject.

The systems, devices and methods of this invention can use a combination of patient-specific health care information and medical bioindicator data to determine disease diagnosis and prognosis for a patient, and to provide wellness healthcare. Further, embodiments of this invention provide patient-specific treatment and/or wellness plans by processing and transforming health care information and medical bioindicator data. Because the treatment and/or wellness plans can be tailored for patient-specific conduct, lifestyle and biochemistry over a period of time, this invention can provide patient care management for personalized healthcare or wellness care.

Systems for Delivering Health Care

A system of this disclosure can include a device having a portal that allows an individual subject or patient to enter and store personal health indicator communications, personal health data, as well as health history information. A system of this disclosure for delivering patient health care can store patient clinical laboratory results, insurance information, provider and clinician information, as well as schedule appointments, provide invoices and receipts for claims and reimbursements, and other medical treatments.

In some aspects, this invention can provide systems and methods for managing healthcare delivery including delivery of medications, pharmaceuticals, nutraceuticals, nutritional supplements, nutrition products; vitamin supplements, and dietary supplements.

In further aspects, this invention can provide systems and methods for healthcare wellness delivery to subjects, where the subjects can take control of their personal healthcare needs.

In additional aspects, this disclosure provides methods for enhancing the health service of a clinician, physician, medical clinic, or health care provider. Service enhancement can be obtained through application of the healthcare solutions, treatment and/or wellness plans, and/or healthcare products and devices of this invention. Enhancing the service for providers can lower the overall cost of health care.

As used herein, healthcare delivery can include delivery of medical information, medical diagnosis or prognosis, treatment and/or wellness plans, as well as delivery of health care products such as medications, nutraceuticals, and dietary supplements, among others.

In some embodiments, the systems and methods of this disclosure can include steps for providing healthcare products to subjects.

In certain embodiments, the output of a device can include, for example, a treatment and/or wellness plan that can be linked and delivered directly to a fulfillment center to provide one or more health products to a subject.

The systems and methods for healthcare delivery of this disclosure can include medical records management. In some aspects, medical records can follow standards for interoperability of health information technology disclosed by Health Level Seven International (HL7).

A subject user account may include subject medical information including personal health indicator communications. Patient personal health indicator communications can be obtained from personal interactions of a patient with a clinician or provider, through visits with a physician, through use of a patient health indicator questionnaire, or through interactions in an electronic social network forum.

In some embodiments, personal health indicator communications can be obtained by a sensor or detector that is worn or used by a subject, where the personal health indicator communications from the sensor or detector are downloaded or transmitted to be received by a processor of the system.

For example, a sun exposure detector may be worn or used on clothing of a subject, or worn or used as an ornament or fashion accessory by a subject, or worn or used in a wearable computing device. Personal health indicator communications from the sensor, device or detector can be downloaded or transmitted to be received by a processor of the system.

In some aspects, this invention provides systems utilizing subject user accounts that may include subject diagnostic laboratory data for bioindicator levels. A user account can be linked through an internet portal to diagnostic laboratories, as well as to clinics, physicians and other health care providers.

A system and device of this disclosure can perform differential diagnosis of a disease state using subject medical information including personal health indicator communications and patient bioindicator levels.

In some embodiments, the systems and methods of this disclosure can include steps for obtaining subject personal health indicator communications.

In further embodiments, the systems and methods of this disclosure can include steps for obtaining patient clinical and health bioindicator level data.

In certain embodiments, the systems and methods of this disclosure can include steps for assessing, scoring and/or assigning the impact level of personal health indicator communications and bioindicator data.

In some aspects, this invention can provide healthcare recommendations and treatment plan options for a subject.

A system and device of this disclosure can recommend treatment and/or wellness plans and options. The input data used to determine treatment and/or wellness plans and options can include data and observations from providers, clinicians, physicians, nurses and other medical practitioners.

A system and device of this disclosure can display health information including bioindicator and personal health indicator communications. The display can include patient diagnoses and prognoses, as well as treatment plans and options, and modified treatment plans and options.

In certain embodiments, the systems and methods of this disclosure can include steps for obtaining input data and/or electronic health records from a healthcare provider, diagnostic laboratory, or clinical laboratory.

In some embodiments, the systems and methods of this disclosure can include steps for receiving and/or reporting out subject bioindicator levels.

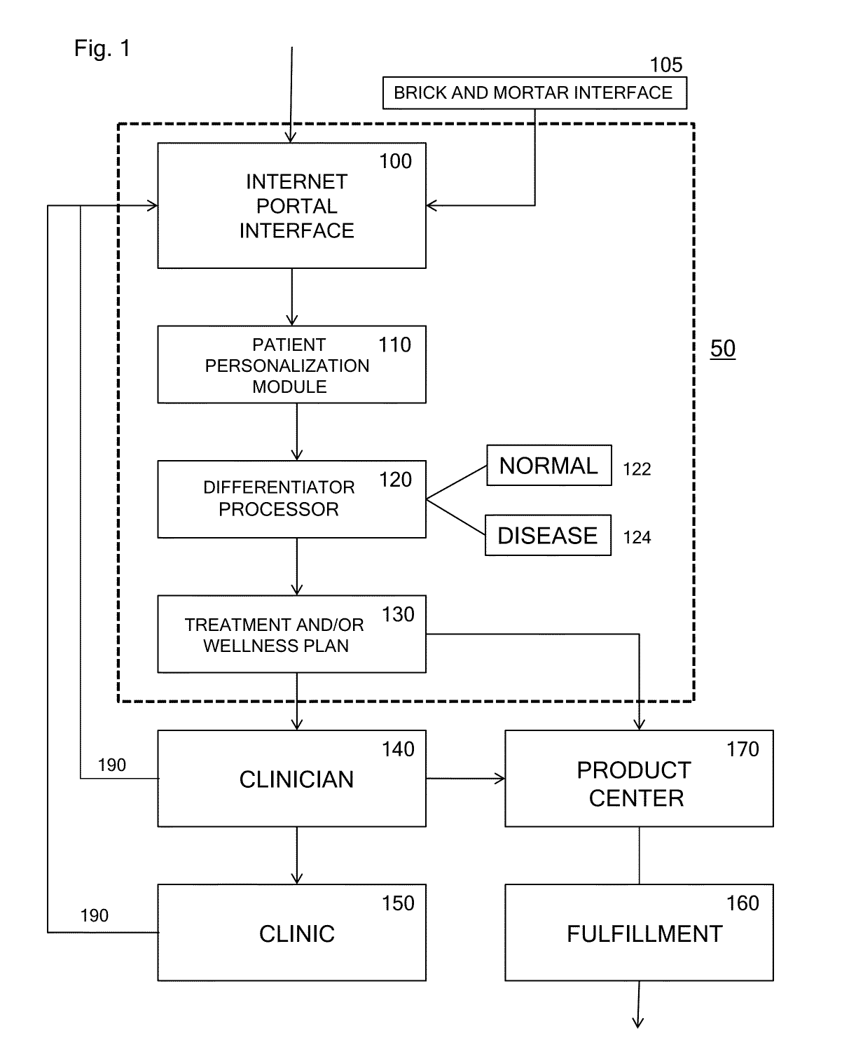

FIG. 1 shows a schematic describing embodiments of a system of this invention. A system for healthcare and/or wellness delivery of this disclosure can include a diagnosis-prognosis device 50 having at least a portal, a differentiator processor, a display, and various modules. The portal can be an internet portal 100 through which data and communications can be obtained or entered. The internet portal 100 can include landing pages, user login and secure access to user accounts. The portal can be a brick and mortar portal 105 in which data and communications can be obtained or entered.

The internet portal 100 can be used for receiving and storing in a patient personalization module 110 one or more patient data such as bioindicator levels. The internet portal 100 can further be used for receiving and storing in the patient personalization module 110 one or more patient personal indicator communications.

The patient personalization module 110 can be used to assign relational impact factors or scores to the data and communications stored therein.

As shown in FIG. 1, a system for healthcare and/or wellness delivery of this disclosure can include a differentiator processor 120 for determining differences between patient data stored in the patient personalization module 110 and a normal patient data stored in a normal patient data module 122 and generating a score. The differentiator processor 120 can also be used for determining differences between patient data stored in the patient personalization module 110 and a disease patient data stored in a disease patient data module 124. The differentiator processor 120 can further be used for determining a patient diagnosis based on the differences, as well as generating a treatment and/or wellness plan and outputting the result to a treatment and/or wellness plan module 130. The treatment and/or wellness plan can also be outputted to a display for creating a visualization of the treatment and/or wellness plan.

In some embodiments, the differences between patient data stored in the patient personalization module 110 and a normal patient data stored in a normal patient data module 122 or disease patient data stored in a disease patient data module 124 may be differentiating distances which are Hamming distances.

The treatment and/or wellness plan module 130 of the diagnosis-prognosis device 50 can be linked directly to a product center 170 which can provide products needed for the treatment plan to a fulfillment center 160 or to brick and mortar or retail centers.

The fulfillment center 160 can provide products directly to a patient or subject according to the treatment plan.

As shown in FIG. 1, the diagnosis-prognosis device 50 of a system for healthcare and/or wellness delivery of this disclosure can be accessed securely by a clinician 140 or other provider in feedback loops 190 to allow follow-on patient information to be obtained through the internet portal 100. Follow-on patient information may also be obtained through the brick and mortar interface 105. A clinician 140 or other provider can also securely access the display of the treatment and/or wellness plan module 130, and can directly access the product center 170 to facilitate, modify or override the treatment plan provided by the diagnosis-prognosis device 50. A clinician 140 or other provider can also interface and instruct a clinic 150 to obtain patient data or information to be provided to the diagnosis-prognosis device 50 through the internet portal 100.

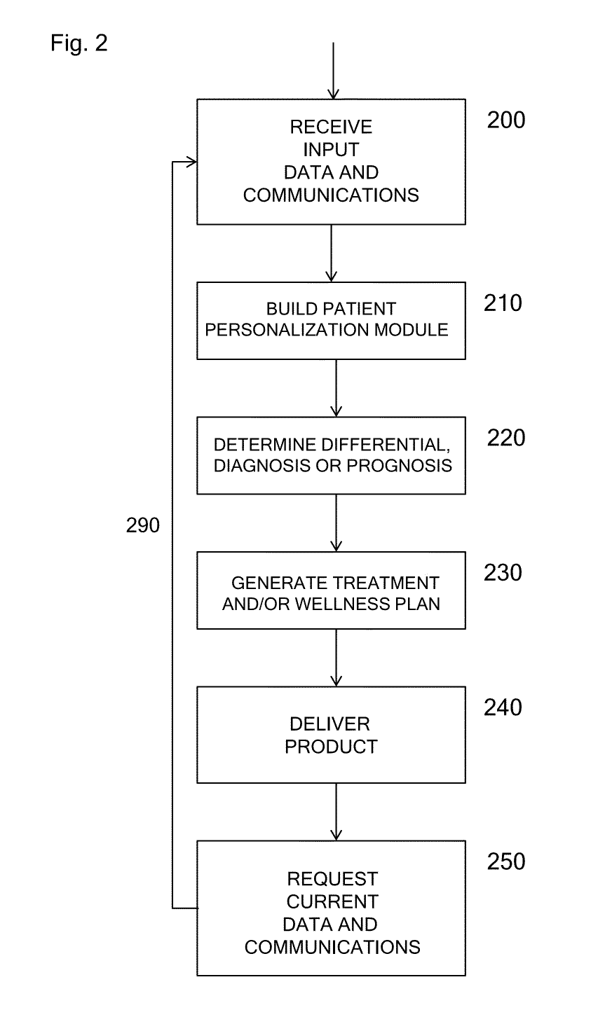

FIG. 2 shows a flowchart of operational features of a system for healthcare and/or wellness delivery that includes a diagnosis-prognosis device. In operation 200, signals relaying patient bioindicator data and patient personal health indicator communications are received via Ethernet, local network link, cellular, or other transmission, or can be entered via an internet portal.

In operation 210, signals relaying patient bioindicator data and patient personal health indicator communications are stored and assembled in a patient personalization module.

In operation 220, a processor receives input from the patient personalization module and processes the patient data with input from disease and normal data modules. In operation 220, a processor determines differentials, diagnosis and/or prognosis that is used to generate a treatment and/or wellness plan in operation 230.

In operation 230, the differentials, diagnosis or prognosis are used to generate a treatment and/or wellness plan, and among other things, can display the differentials, diagnosis or prognosis along with the treatment and/or wellness plan. The display creates a visualization of the differentials, diagnosis or prognosis along with the treatment and/or wellness plan which can be accessed by clinicians and subjects.

In operation 240, the treatment plan is received by a product center which is linked to a fulfillment center to provide product to the patient under the treatment plan.

In operation 250, requests can be made to subjects, providers or clinicians to provide current or follow-on patient bioindicator data and patient personal health indicator communications.

In operation 290, current or follow-on patient bioindicator data and patient personal health indicator communications can be sent in a feedback loop to a portal.

Personalized Healthcare and Wellness

In some embodiments, this disclosure provides systems and methods for personalized regimens for delivery of healthcare and wellness, including treatment of subjects for various diseases, states and conditions. A system and device of this disclosure can allow subjects to self-monitor and manage their own bioindicator levels and healthcare/wellness outcome.

A personalized healthcare/wellness delivery method of this invention can include steps for gathering subject habitual, corporeal and personal data and health indicator communications. In some embodiments, subject or patient personal health indicator communications can be obtained from a clinician, physician or other provider, as well as through use of a patient health indicator questionnaire, or through interactions in an electronic social network forum.

A system and device of this disclosure can provide a subject with treatment options based on a diagnosis. In some embodiments, a personalized healthcare/wellness delivery method of this invention can include steps for determining a personalized therapeutic plan for improving health.

A system and device of this disclosure can advantageously match a subject with the appropriate treatment for a disease or condition, and provide steps for tracking the health of a subject. A subject can manage a personalized therapy or treatment-wellness plan to achieve a treatment-wellness objective.

A system and device of this disclosure can include a personalized health or wellness journal for storing and displaying a time log of health information related to an ongoing a treatment plan, or to subject habitual input data. A personalized health journal can provide reminders and records of pertinent activities, such as exercise, and diet and progress toward goals. A personalized health journal can include a mobile application for a direct interface to the system or device.

A mobile application can send reminders to a subject for the treatment plan. The reminders can be daily, weekly, or at any other intervals. The reminders carry out the treatment plan, for example, for the subject to consume a supplement dose of a desired strength, or a desired dosing regimen. The mobile application may have a status visualizer for a smart-phone that would indicate the need to carry out a step of the treatment plan. The mobile application may have an interactive feature which allows the subject to respond in real-time to confirm compliance of the treatment step. The mobile application may have a communication ability by sending, for example, a cellular or Wi-Fi signal, or by smart-phone bumping, or by text or e-mail, to communicate with a healthcare or wellness device or system of this invention.

In some embodiments, This enable the wellness program to monitor and report on compliance in the program.

In some embodiments, a subject can proactively manage healthcare/wellness treatment. In certain embodiments, a subject can proactively manage vitamin D levels.

Device and Processor for Diagnosis, Prognosis and Patient Care

A system for healthcare delivery of this disclosure can include a diagnosis-prognosis device that uses a processor to determine differences between a patient's condition and normal and disease states.

As used herein, a normal state can be represented through bioindicator levels and normal state health information including normal subject habitual, corporeal and personal data and health indicator communications.

As used herein, a disease state can be represented through bioindicator levels and disease state health information including disease subject habitual, corporeal and personal data and health indicator communications.

In some embodiments, the bioindicators are genomic, proteomic, or clinical. Examples of clinical bioindicator data include blood tests.

The number of bioindicators used in a device or processor of this invention for diagnosis, prognosis or patient care can vary from 1 to 2000, or from 1 to 1000, or from 1 to 500, or from 1 to 100, or from 1 to 50, or from 1 to 30, or from 1 to 20, or from 1 to 10. The number of bioindicators used in a device or processor of this invention for diagnosis, prognosis or patient care can be 1, or 2, or 3, or 4, or 5, or 6, or 7, or 8, or 9, or 10, or 15, or 20, or 30, or 40, or 50, or 100, or 200, or 500, or 1000, or 2000.

In certain embodiments, the personal indicators are habitual, corporeal, geographical, temporal, seasonal, and physical.

Data and communications relating to patient personal indicators can be received or obtained electronically through an internet portal, and entered and stored in a patient personalization module. Each of the patient data and communications can be assign a relational impact factor, and a score can be generated from the data or communications with the relational impact factor.

A differentiator processor in a device of this invention can be linked to a normal state module. The normal state module can include bioindicator levels and personal indicator communications for subjects in a normal state. In operation, the differentiator processor can receive signals from the normal state module representing data to be used for calculating a differentiating distance between a patient state and a normal state.

A differentiator processor in a device of this invention can be linked to a disease state module. The disease state module can include bioindicator levels and personal indicator communications for subjects in a disease state. In operation, the differentiator processor can receive signals from the disease state module representing data to be used for calculating a differentiating distance between a patient state and a disease state.

The differentiator processor of the a diagnosis-prognosis device may be used for determining differences, such as differentiating distances, between patient data and communications stored in the patient personalization module and normal and disease patient data. The differences or differentiating distances can be used for determining a patient diagnosis or prognosis.

The differentiator processor may be used for determining a patient score. A patient score can be based on the number and degree of differences, for example differentiating distances, between patient data and communications stored in the patient personalization module and normal and disease patient data.

In general, a first patient score representing the distance between patient data and disease data being lower than a second patient score representing the distance between patient data and normal data can represent a diagnosis of a disease state.

In general, a first patient score representing the distance between patient data and disease data being higher than a second patient score representing the distance between patient data and normal data can represent a diagnosis of a normal state.

In general, a number of patient states can be found between a disease state and a normal state.

A patient score can be based solely on patient communications stored in the patient personalization module.

Examples of disease states include vitamin deficiency.

A differentiator processor in a device of this invention can process patient bioindicator levels and patient personal indicator communications to determine differences, such as differentiating distances, based on one or more of patient bioindicator levels, patient bioindicator T-scores, patient bioindicator Z-scores, Hamming distances based on patient personal indicators and normal and disease data, and combinations thereof.

In operation, a differentiator processor in a device of this invention can receive signals representing current or follow-on data to be used for calculating a patient diagnosis or prognosis.

A differentiator processor in a device of this invention can process patient current bioindicator levels and patient current personal indicator communications to determine additional follow-on differentiating distances based on one or more of patient current bioindicator T-scores, patient current bioindicator Z-scores, Hamming distances based on patient current personal indicators, and combinations thereof.

In operation, a differentiator processor in a device of this invention can determine a patient prognosis through the changes in follow-on differences, such as differentiating distances, as compared to previously-obtained differences for the patient.

The prognosis for a subject can reflect an improvement in health where the differences between the current patient state and a disease state are increasing, and/or the differences between the current patient state and a normal state are diminishing.

The prognosis for a subject can reflect an improvement in health where the differences, such as differentiating distances, change because of changes in patient current bioindicator levels and patient current personal indicator communications, or because of a change only in one or more patient current bioindicator levels, or because of a change only in one or more current personal indicator communications.

A differentiator processor in a device of this invention can generate and output a treatment plan. The differentiator processor can process patient original and follow-on bioindicator levels and patient original and follow-on personal indicator communications. The modalities for processing patient original and follow-on bioindicator levels and patient original and follow-on personal indicator communications include residual error prediction, ADME analysis, regression analysis, and principal component analysis.

In certain embodiments, a differentiator processor in a device of this invention can generate and output a purchase request to an outside vendor or healthcare provider.

In some embodiments, the personal indicator communications from a questionnaire, for example, can include the kind of dose preferred. For example, personal indicator communications can specify a tablet, softgel, or liquid form for a supplement. Personal indicator communications may specify if the formulation should be organic or vegan, or whether or not it should contain dye. A differentiator processor can utilize these personal indicator communications to generate and output a purchase request to an outside vendor or healthcare provider. A differentiator processor can have an interactive feature in which a library of product or supplement options is generated based on the personal indicator communications and offered to the subject.

A differentiator processor in a device of this invention can be linked to a treatment plan module. In operation, the treatment plan module can receive signals from the differentiator processor representing a treatment plan, a diagnosis or prognosis, and differences such as differentiating distances between a patient state and disease and normal states. The treatment plan module can include a display for visualizing a treatment plan, a diagnosis or prognosis, and the differentiating distances.

In some embodiments, a physician or clinician can access the display of the treatment module to facilitate, modify or override the treatment plan as provided by the diagnosis-prognosis device.

In certain aspects, a final diagnosis can be made by a licensed physician communicating through a network portal. Examples of network portals include TELEHEALTH and other tele-health portals.

In some embodiments, this invention includes a method for determining the vitamin D biomarker level of a subject. The vitamin D biomarker level of a subject can be determined by receiving personal indicator communications as input to a processor in the form of one or more results or answers to a questionnaire from a subject and forming a patient personal assessment by operating a patient personalization processor for receiving the input. The processor assigns relational impact factors to the input, thereby providing the patient personal assessment. The vitamin D biomarker level of a subject can be determined by operating a processor to transform the patient personal assessment into a corresponding vitamin D biomarker level for the subject using blood test results and corresponding questionnaire results for a set of previously-tested subjects. The accuracy of the corresponding vitamin D biomarker level for the subject is found to be at least 75% as compared to a blood test result for blood 25(OH)D levels. In some embodiments, the accuracy of the corresponding vitamin D biomarker level for the subject is found to be at least 90% as compared to a blood test result.

In some embodiments, a vitamin D biomarker level of a subject can be determined by receiving personal indicator communications as input to a processor in the form of one or more signals transmitted by a sensor, device or detector that is worn or used by a subject. For example, the sensor, device or detector may measure and transmit information concerning the sun exposure of a subject in real-time, or as a time average.

In some embodiments, a relational impact factor can be assigned to a personal indicator communication.

Social Networking

In some aspects, the systems and methods of this disclosure can provide an electronic social network forum for discussing the diagnosis and/or treatment of a disease. The forum may allow subjects to participate anonymously using avatars to provide data and information regarding the diagnosis or treatment of a disease or condition.

In some embodiments, the forum can provide access to providers, clinicians, physicians, nurse and other medical practitioners. A provider or clinician may have an electronic certificate or badge for identification in the forum.

Patient Personal Health Indicator Communications

In some embodiments, this invention includes steps for obtaining patient personal indicator communications. Patient personal indicator communications can be obtained from personal interactions of a patient with a physician, clinician, nurse or other health care provider, through in-person visitation, or through use of a patient health indicator questionnaire, online, or through communications in an electronic social network forum or via a patient self-health journal.

Patient personal indicator communications can be electronically received and stored in a patient personalization module of a device of this invention.

In some aspects, patient personal indicator communications can include factual data or clinical data, as well as communications regarding are habitual, corporeal, geographical location, temporal, seasonal, and physical factors or events.

Examples of habitual patient personal indicator communications include daily sun exposure activity.

In some embodiments, patient personal indicator communications can include patient corporeal and health information such as personal medical history, family medical history, personal height, personal weight, personal body mass index, personal waist circumference, personal blood pressure, and personal functional ability.

In some embodiments, patient personal indicator communications can include patient communications regarding homeostasis, well-being, and/or wellness.

Taking Control of Vitamin D Levels

In certain embodiments, this disclosure provides systems and methods for personalized regimens for treatment and delivery of healthcare for managing vitamin D in a subject.

A personalized regimen of this invention can include delivery of a pharmaceutical, a nutraceutical, or a nutritional supplement. For example, a personalized regimen of this invention can include delivery of a vitamin-D formulation. In certain embodiments, a vitamin-D formulation can include a multi-vitamin composition.

This disclosure provides methods for managing vitamin D bioindicator levels such as blood 25(OH)D levels by providing personalized vitamin D supplementation to a subject for achieving target bioindicator blood levels over time.

Examples of patient personal indicator communications can include factual data such as patient travel events or plans which can affect vitamin D levels. In some embodiments, systems and methods for managing vitamin D in a subject include adjusting the dose according to patient travel events or plans. In certain embodiments, the dose can be increased because of patient travel events or plans which would reduce sun exposure. The dose may subsequently be adjusted to account for current levels after patient travel events are completed. In other embodiments, the dose can be decreased because of patient travel events or plans which would increase sun exposure. The dose may subsequently be adjusted to account for current levels after patient travel events are completed.

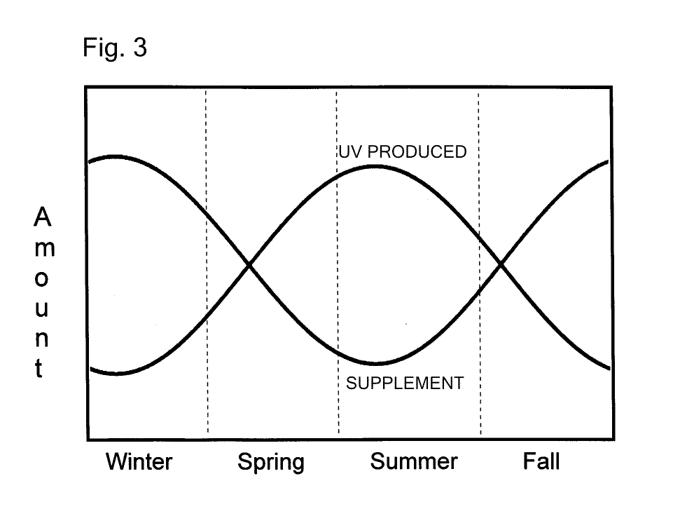

For example, FIG. 3 shows a schematic of an example of delivering health care by enabling a patient to monitor and balance biophysical processes for improving health. In this example, the amount of vitamin D produced by exposure to UV light varies substantially over time. The maximum is during the summer between the hours of 10:00 am and 2:00 pm. The lower the latitude, the more intense the UV radiation, and the more natural Vitamin D3 is produced. Under a treatment plan of this disclosure, a patient can monitor and balance actual vitamin D levels using supplement levels determined by a diagnosis-prognosis device of this disclosure. The supplement supplied is in direct contrast to the amount made in the body, so the patient receives the largest dose of vitamin D in the winter, and the least in the summer.

A personalized wellness healthcare or personalized medicine delivery method of this invention can include steps for gathering subject health data including blood 25(OH)D levels. For example, a personalized therapeutic plan for improving vitamin D health can be formed using subject corporeal data including weight, age, sun exposure, and expected metabolic utilization rate.

In certain embodiments, this invention provides methods for treating vitamin D deficiency using therapeutic dosages of Vitamin D3 in a recurring subscription delivery program to titrate and maintain vitamin D levels in a subject to within a normal range.

In further embodiments, a treatment plan may use a subject pharmacokinetic profile. For example, the dose for a 20 year old female weighing 100 lbs will be different than that of a 220 lb 50 year old male.

A treatment plan may use single dose blister packs having a supply of doses for a period of time, such as for one week, one month, or longer.

Embodiments of this invention may also provide a vitamin D treatment plan to raise vitamin D levels in a subject to a level of 40-60 ng/mL, or 50-80 ng/mL. A vitamin D treatment plan may use a 50 to 50,000 IU dosage, or a 500 to 10,000 IU dosage.

A vitamin D treatment plan may take into account patient corporeal data including body type, sex, and age, as well as personal health indicator communications and other health information such as liver function.

A vitamin D treatment plan may use the half-life of 25(OH)D metabolism as a bioindicator for a personalized regimen to ensure that the subject achieves a vitamin D goal of 40-60 ng/mL and can maintain that level.

In some aspects, the pharmacokinetic or ADME behavior of a drug or nutrient can be used to determine a precise, personalized regimen for delivery, when used in combination with personal health indicator communications and other health information.

As used herein, the term vitamin D deficiency refers to a 25(OH)D blood level below 40 ng/mL.

As used herein, the term vitamin D refers to all forms of vitamin D, if not otherwise specified.

In some variations, a subject can be tested for vitamin D bioindicator status to determine a deficiency, for example 25(OH)D blood level. A subject can be instructed to obtain a clinical test for a vitamin D bioindicator status. A dosing regimen of vitamin D may be used to change the subject's vitamin D level to achieve a target level of from 40 to 60 ng/mL. A dosing regimen of vitamin D may further be used to maintain a vitamin D level of from 40 to 60 ng/mL.

In certain embodiments, dosage forms having four different levels of vitamin D may be used to reach the vitamin D target level. In further embodiments, dosage forms having five, six, seven, eight or more different levels of vitamin D may be used to reach the vitamin D target level.

In some aspects, embodiments of this invention provide the clinical dosing schedule by a determination using pharmacokinetic behavior, test results showing the initial vitamin D level, and metabolism parameters such as age, sex, and weight, and creatinine clearance rate. The clinical dosing schedule can be adjusted to maintain a vitamin D level of from 40 to 60 ng/mL.

In certain embodiments, levels for vitamin D-25-OH, bilirubin, creatinine, and ratios of the foregoing may be obtained by blood test.

A system and device of this disclosure can include a secure data exchange protocol to transfer and store subject data. For example, clinical results may be sent directly to a device of this invention.

A treatment plan for vitamin D deficiency may utilize a vitamin D dose to raise the vitamin D level of a subject. In some embodiments, a treatment plan for vitamin D deficiency may utilize a vitamin D dose of 9,000 IU to raise the vitamin D level of a subject to reach a target blood level of 25(OH)D of 40-60 ng/mL. The vitamin D dose supplied may be altered during the subscription phase and tailored to the individual subject, as determined by a device of this invention. The vitamin D dose supplied may range from 500 IU to 3000 IU, or from 500 IU to 6000 IU, or from 500 IU to 9000 IU. Further, the vitamin D dose supplied may be changed over time to reflect a treatment plan determined by a device of this invention based on patient bioindicator levels and/or patient personal indicator communications. In certain embodiments, the vitamin D dose supplied may range from 50 IU to 50,000 IU.

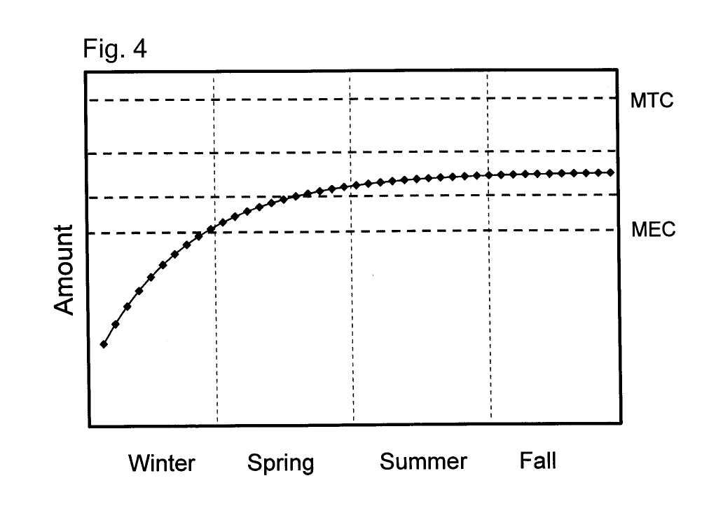

FIG. 4 shows a schematic of an example of delivering health care by enabling a patient to monitor and balance biophysical processes for improving health. In this example, the amount of vitamin D in a patient is titrated to a constant level from 40 to 60 ng/mL over time which falls in a recommended range, for example from 4 to 6 months. Using a diagnosis-prognosis device of this disclosure to determine on-going vitamin D dosages, the patient can achieve the desired result regardless of changes in behavior or changes in biological responses that cannot be predicted.

In FIG. 4, The Minimum Effective Concentration (MEC) is the level below which vitamin D is considered too low, which can be 20 ng/mL in an adult subject. The Minimum Toxic Concentration (MTC) is the level that is considered to be too high and may lead to unwanted side-effects. The MTC is about 100 to 200 ng/mL. Thus, the upper level of the target range of about 60 ng/mL is less than one-third of the MTC level of 100 to 200 ng/mL.

FIG. 4 shows that it can be a slow process to increase the level of vitamin D in the body. Increasing the level of vitamin D in the body may require more vitamin D3 than a subject is expected to consume. The dose should take into account the time of year, body size, metabolism, geographic location, and dietary and sun exposure habits.

FIG. 4 shows that in a treatment plan of this disclosure, the amount of vitamin D in the blood will rise slowly until it is within the target range 40-60 ng/mL.

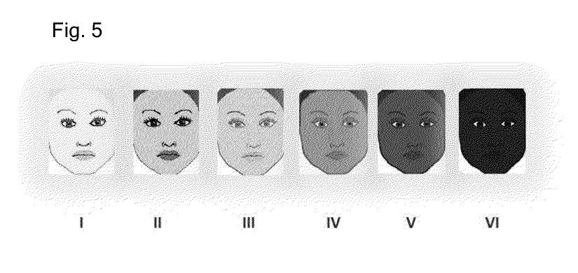

FIG. 5 shows a schematic of a Fitzpatrick skin type scale used for input to a system for vitamin D healthcare delivery including a diagnosis-prognosis device.

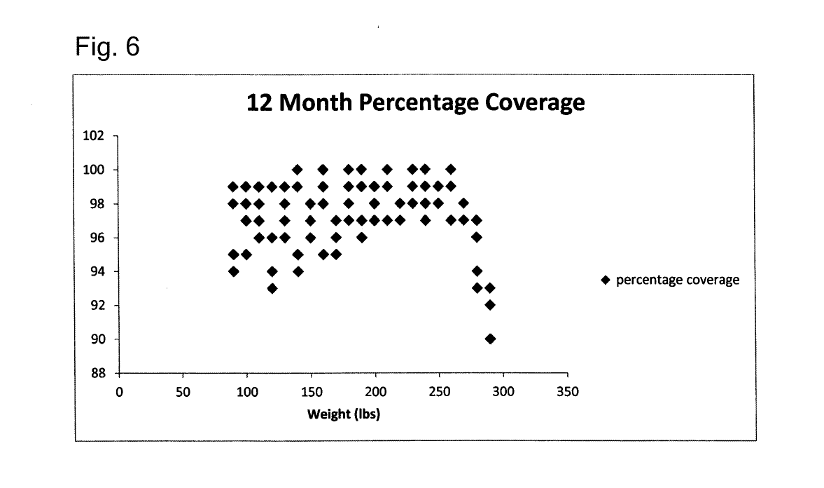

FIG. 6 shows a chart of the achievable levels of vitamin D using a wellness healthcare and/or personalized medicine delivery system including a diagnosis-prognosis device for a model group of patients whose members reflect a wide variation of unpredictable biological responses. The results show that for all but a few of the higher weight patients the amount of vitamin D that is provided within the patient's body over a twelve month period is at least 92% of the recommended annual need.

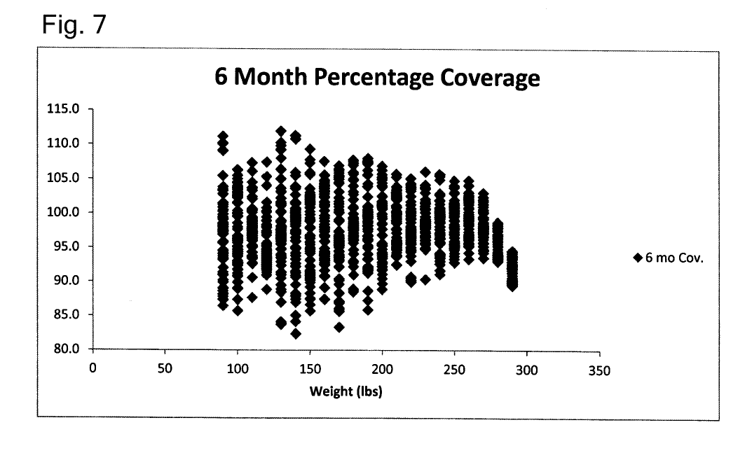

FIG. 7 shows a chart of the achievable levels of vitamin D using a wellness healthcare and/or personalized medicine delivery system including a diagnosis-prognosis device for a model group of patients whose members reflect a wide variation of unpredictable biological responses. The results show that the amount of vitamin D that is provided within the patient's body over a six month period is at least 82% of the recommended need.

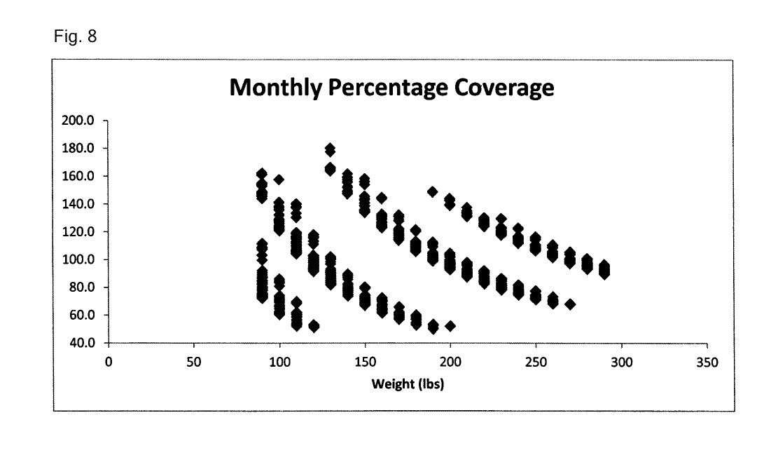

FIG. 8 shows a chart of the achievable levels of vitamin D using a wellness healthcare and/or personalized medicine delivery system including a diagnosis-prognosis device for a model group of patients whose members reflect a wide variation of unpredictable biological responses. The results show that the amount of vitamin D that is provided within the patient's body over a one month period is at least 40% of the recommended need. Optionally, in certain embodiments, a higher dose of vitamin D can be used to achieve a higher level of vitamin D within the patient's body over a one month period.

Wellness Healthcare

A system and device of this disclosure can display health information and treatment plans for wellness healthcare.

In certain aspects, this disclosure provides wellness plans in which a subject engages in proactively improving health.

### Example 1

### Bioindicator Tests

Examples of bioindicators include the clinical tests as shown in Table 1.

TABLE 1
Examples of clinical bioindicator tests
Bioindicator

CWP
Vitamin D-25-OH
Hemoglobin A1c
Lipid Profile
CBC
Hair Elements
Urinalysis, Complete
CWP with Vitamin D, 25-Hydroxy
Comprehensive Metabolic Panel (CMP-14)
TSH
PSA
Thyroid Panel, Special
Thyroid Antibodies Panel
Thyroid Panel w/TSH
Testosterone, Total & Free
PT, INR
Ferritin

The clinical bioindicators shown in Table 1 can be used in a device of this invention.

### Example 2

### Bioindicators

Examples of bioindicators include those shown in Table 2.

TABLE 2
Examples of clinical bioindicators and normal ranges

| Bioindicator | Units | Range |
|---|---|---|
| Cholesterol, Total | mg/dL | 100-199 |
| Triglycerides | mg/dL | 0-149 |
| HDL Cholesterol | mg/dL | >39 |
| LDL Cholesterol Calc | mg/dL | 0-99 |
| T. Chol/HDL Ratio | ratio units | 0.0-5.0 |
| CRP—C-Reactive protein | | |
| TSH | uIU/mL | 0.450-4.500 |
| Thyroxine (T4) | ug/dL | 4.5-12.0 |
| T3 Uptake | % | 24-39 |
| Free Thyroxine Index | ×10E3/uL | 1.2-4.9 |
| WBC | ×10E6/uL | 4.0-10.5 |
| RBC | g/dL | 4.10-5.60 |
| Hemoglobin | % | 12.5-17.0 |
| Hematocrit | fL | 36.0-50.0 |
| MCV | pg | 80-98 |
| MCH | g/dL | 27.0-34.0 |
| MCHC | % | 32.0-36.0 |
| RDW | ×10E3/uL | 11.7-15.0 |
| Platelets | % | 140-415 |
| Fibrinogen | | |
| Homocysteine | | |
| Neutrophils | % | 40-74 |
| Lymphocytes | % | 14-46 |
| Monocytes | % | 4-13 |
| Eos | % | 0-7 |
| Basos | ×10E3/uL | 0-3 |
| Immature Cells | ×10E3/uL | 1.8-7.8 |
| Neutrophils (Absolute) | ×10E3/uL | 0.7-4.5 |
| Lymphocytes (Absolute) | ×10E3/uL | 0.1-1.0 |
| Monocytes(Absolute) | ×10E3/uL | 0.0-0.4 |
| Eos (Absolute) | % | 0.0-0.2 |
| Baso (Absolute) | ×10E3/uL | 0-1 |
| Immature Granulocytes | ug/dL | 0.0-0.1 |
| Immature Grans (Abs) | IU/L | 40-155 |
| NRBC | IU/L | 0-65 |
| Iron, Serum | IU/L | 0-55 |
| GGT | IU/L | 0-40 |
| ALT (SGPT) | IU/L | 100-250 |
| AST (SGOT) | mg/dL | 25-150 |
| LDH | g/dL | 0.0-1.2 |
| Alkaline Phosphatase, S | g/dL | 1.1-2.5 |
| Bilirubin, Total | g/dL | 1.5-4.5 |
| A/G Ratio | mg/dL | 3.5-5.5 |
| Globulin, Total | mg/dL | 6.0-8.5 |
| Albumin, Serum | mmol/L | 2.5-4.5 |
| Protein, Total, Serum | mmol/L | 8.7-10.2 |
| GGT Gamma-glutamyl transpeptidase | | |
| Phosphorus, Serum | mmol/L | 20-32 |
| Calcium, Serum | mmol/L | 97-108 |
| Carbon Dioxide, Total | mL/min/1.73 | 3.5-5.2 |
| Chloride, Serum | mL/min/1.73 | 135-145 |
| Potassium, Serum | mg/dL | 8-27 |
| Sodium, Serum | mg/dL | >59 |
| BUN/Creatinine Ratio | mg/dL | >59 |
| eGFR AfricanAmerican | mg/dL | 0.76-1.27 |
| eGFR | ng/mL | 5-26 |
| Creatinine, Serum | mg/dL | 0.76-1.27 |
| BUN | mg/dL | 5-26 |
| Uric Acid, Serum | mg/dL | 2.4-8.2 |
| Glucose, Serum | mg/dL | 65-99 |
| Glucose, Plasma | | |
| Insulin, fasting | | |
| Prostate Specific Ag, Serum | ng/mL | 0.0-4.0 |
| Vitamin D-25-OH | ng/mL | 40-70 |
| Vitamin B Complex | pg/mL | 200-900 |
| Total T-4 (Thyroxine) | | |
| T-3 Uptake | | |
| Free-Thyroxine Index (FTI) T-7 | | |
| TSH Thyroid-stimulating hormone, | | |
| thyrotropin | | |
| Vitamin A | | |
| Vitamin B1 | | |
| Vitamin B6 | | |
| Vitamin B9 (Folic Acid): | | |
| Vitamin B12 | | |
| Vitamin C | | |
| Vitamin E | | |
| Vitamin K | | |

In Table 2, the range of values shown for each of the clinical bioindicators is the normal level range for the bioindicator.

### Example 3

### Vitamin D Data and Personal Health Communications

Patient corporeal data and Vitamin D personal health communications can be used to manage Vitamin D levels.

Vitamin D related health data include date of birth, gender, weight, height, and pregnancy.

Examples of Vitamin D specific personal health indicator communications include skin type, diet, servings per day on average of fish, and eggs, international units (IU) of vitamin D3 taken daily and duration of intake, sun exposure such as average hours of outdoor sun exposure, frequency of use of sunscreen outdoors, use of tanning equipment and duration, amount of skin area exposed, and frequency of outdoor sunbathing or sun-exposure.

Examples of personal health indicator communications include skin type which is shown in Table 3, and FIG. 5.

TABLE 3
Skin type for Vitamin D specific health

Sun exposure

| No | Skin characteristics | Tanning | Sunburn |
|---|---|---|---|
| 1 | Very pale or ruddy | Rarely | Frequently |
| 2 | Pale or light-toned | Lightly | Usually |
| 3 | Olive | Moderately | Occasionally |
| 4 | Light brown | Easily | Seldom |
| 5 | Brown | Darkly | Rarely |
| 6 | Dark brown | — | Never |

### Example 4

### Vitamin D Deficiency Control and Management

Vitamin D is a fat-soluble seco-steroid vitamin that may play a role in a wide variety of diseases and conditions. Vitamin D deficiency can result in serious healthcare problems. Vitamin D is produced naturally by exposure to sunlight. Vitamin D3 is naturally made in skin when exposed to UV-B radiation from sunlight. For example, without sunblock on a sunny summer day at the beach between 10:00 am and 2:00 pm for 20 minutes, the body may produce from about 10,000 to 20,000 IU or more of Vitamin D3. In general, the darker the skin tone, the longer it takes to make vitamin D3 in the skin.

Vitamin D deficiency is prevalent in the United States. Vitamin D deficiency involves as much as 70% of the population in some regions of the world. Global vitamin D deficiency may have many causes, including limited sun exposure, and inadequate dietary and supplement sources.

The Vitamin D Council recommends a target healthy level for vitamin D of from 50-80 ng/mL. According to Grassroots Health, a target healthy level for vitamin D in blood is the range from 40-60 ng/mL of 25(OH)D. However, the US government-recommended daily intake levels may be inadequate to provide the effective supplementation needed to reach those blood levels.

In general, Vitamin D exists in three forms in the body. It is generally referred to as “vitamin D,” but each of the three forms plays a role in the function of vitamin D activity. This should not be confused with “vitamin D2,” which is ergocalciferol, a less potent mushroom-derived form of vitamin D. (1) Cholecalciferol, Vitamin D3, is the form of vitamin D made from sunlight and found in most supplements. It is the inactive precursor to califediol. (2) Calcifediol, 25-hydroxycholecalciferol, 25(OH)D. The form that is measured in the blood test to measure vitamin D status. It is a prehormone to calcitriol. (3) Calcitriol, 1,25-dihydroxyvitamin D3. The metabolically active secosteroid form of vitamin D which binds to the vitamin D receptor. This does all the work in the body.

In some embodiments, a wellness plan for Vitamin D may include any of the steps: providing a healthy regulated level of vitamin D year-around, managing a high dose vitamin D supplementation, titrating to a health safe level of 40 to 60 ng/mL, monitoring vitamin D blood level and tracking it over time, achieving sufficient levels of vitamin D and checking to confirm, providing the health benefits of vitamin D, providing serenity by ensuring a specific vitamin D target is met, regulating vitamin D nutrition for optimal health, achieving a certain range of vitamin D levels, measuring vitamin D levels, controlling vitamin D levels, keeping vitamin D levels stable all year around, providing a balanced vitamin D-containing multivitamin, changing the dose of vitamin D throughout the year.

Steps for managing Vitamin D may include:

(1) Input Values of Vitamin D3: Determine input rate from all sources.

(2) Calculate the sunshine input rate using latitude, season, skin tone, % skin exposed, and outdoor sunlight habits.

(3) Determine the UV-B vitamin D3 conversion rate using the sunshine input rate.

(4) Assume that 1 SED (Standard Erythemal Dose) is the average daily UV exposure. Adjust using the Action Spectrum Conversion Factor (ASCF), which allows modification of the UV intensity depending on latitude.

(5) In this example, the level of vitamin D3 supplementation may be from

IU to 10,000 IU per day. Take into account the subject age, weight, diet, skin-tone and sun exposure. Metabolic rate varies from about 3,000 to 6,000 IU daily.

A percent body exposure factor is shown in Table 4.

TABLE 4
Percent Body Exposure Factor
Percent Body Exposure

Age (Years)

| Exposure (%) | 0-5 | 10 | 15 | ≧22 |
|---|---|---|---|---|
| Half of head (face) | 7.8 | 5.5 | 4.5 | 3.5 |
| Half of neck (front) | 1 | 1 | 1 | 1 |
| Hands (front and back) | 5 | 5 | 5 | 5 |
| Lower arms | 6 | 6 | 6 | 6 |
| Lower legs | 10 | 12 | 13 | 14 |
| Half of upper arms | 4 | 4 | 4 | 4 |
| Half of upper legs | 7 | 8.5 | 9 | 9.5 |

Total

| | | | | |
|---|---|---|---|---|
| Winter | 13.8 | 11.5 | 10.5 | 9.5 |
| Spring/Fall | 30 | 29.5 | 29.5 | 15.5 |
| Summer | 40.8 | 42 | 43.5 | 33.5 |

For Summer only

| | | | | |
|---|---|---|---|---|
| Upper arms | 8 | 8 | 8 | 8 |
| Upper legs | 14 | 17 | 18 | 19 |
| Trunk | 26 | 26 | 26 | 26 |
| Feet | 7 | 7 | 7 | 7 |
| Bathing Suit/Diaper | 85.6 | 88.5 | 89.5 | 90.5 |

An action spectrum conversion factor is shown in Table 5.

TABLE 5
Action Spectrum Conversion Factor (ASCF)
Action Spectrum Conversion Factor (ASCF)

| Latitude | Summer | Fall | Winter | Spring |
|---|---|---|---|---|
| 60° N | 0.951 | 0.601 | 0.269 | 0.742 |
| 55° N | 0.986 | 0.71 | 0.344 | 0.805 |
| 50° N | 1.013 | 0.802 | 0.453 | 0.857 |
| 45° N | 1.034 | 0.879 | 0.565 | 0.9 |
| 40° N | 1.067 | 0.963 | 0.7 | 1.008 |
| 35° N | 1.104 | 1.029 | 0.842 | 1.049 |
| 30° N | 1.11 | 1.061 | 0.91 | 1.065 |

An age factor is shown in Table 6.

TABLE 6
Age Factor (AF)
Age Factor (AF)

| Age | AF | Mean Age | AF |
|---|---|---|---|
| <22 | 1 | 11 | 1 |
| 22-40 | 0.83 | 31 | 0.83 |
| 41-59 | 0.66 | 50 | 0.66 |
| >60 | 0.49 | 70 | 0.49 |

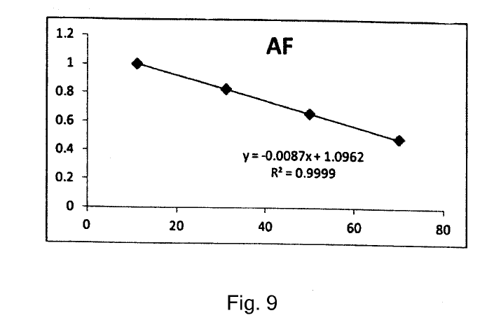

A chart of the age factor is shown in FIG. 9.

A geographical factor is shown in Table 7.

TABLE 7
Geographical Factor

| | | Summer | | Winter | |
|---|---|---|---|---|---|
| | | Semi- | Summer | Semi- | Winter |
| Latitude | Weighting | Cylinder | Horizontal | Cylinder | Horizontal |
| 70° N | None | 0.702 | 0.517 | 0.763 | 0.578 |
| | Eeff | 0.689 | 0.505 | 0.726 | 0.542 |
| | Deff | 0.684 | 0.499 | 0.71 | 0.528 |
| 65° N | None | 0.681 | 0.497 | 0.763 | 0.578 |
| | Eeff | 0.674 | 0.49 | 0.728 | 0.544 |
| | Deff | 0.67 | 0.485 | 0.714 | 0.529 |
| 60° N | None | 0.57 | 0.478 | 0.756 | 0.572 |
| | Eeff | 0.659 | 0.475 | 0.725 | 0.541 |
| | Deff | 0.656 | 0.471 | 0.713 | 0.529 |
| 55° N | None | 0.645 | 0.46 | 0.749 | 0.564 |
| | Eeff | 0.645 | 0.461 | 0.72 | 0.535 |
| | Deff | 0.642 | 0.458 | 0.709 | 0.524 |
| 50° N | None | 0.629 | 0.445 | 0.737 | 0.552 |
| | Eeff | 0.631 | 0.448 | 0.711 | 0.527 |
| | Deff | 0.63 | 0.446 | 0.701 | 0.517 |
| 45° N | None | 0.615 | 0.431 | 0.72 | 0.535 |
| | Eeff | 0.62 | 0.436 | 0.7 | 0.515 |
| | Deff | 0.618 | 0.434 | 0.692 | 0.508 |
| 40° N | None | 0.603 | 0.42 | 0.7 | 0.515 |
| | Eeff | 0.61 | 0.426 | 0.687 | 0.502 |
| | Deff | 0.608 | 0.425 | 0.681 | 0.496 |
| 35° N | None | 0.594 | 0.41 | 0.68 | 0.496 |
| | Eeff | 0.601 | 0.418 | 0.658 | 0.488 |
| | Deff | 0.6 | 0.417 | 0.655 | 0.484 |
| 30° N | None | 0.586 | 0.403 | 0.661 | 0.477 |
| | Eeff | 0.594 | 0.411 | 0.658 | 0.474 |
| | Deff | 0.593 | 0.41 | 0.655 | 0.471 |
| 25° N | None | 0.58 | 0.397 | 0.644 | 0.46 |
| | Eeff | 0.589 | 0.406 | 0.645 | 0.461 |
| | Deff | 0.588 | 0.405 | 0.642 | 0.458 |
| 20° N | None | 0.577 | 0.394 | 0.628 | 0.444 |
| | Eeff | 0.586 | 0.403 | 0.632 | 0.448 |
| | Deff | 0.586 | 0.402 | 0.63 | 0.446 |

A standard erythemal dose adjustment is shown in Table 8.

TABLE 8
Standard Erythemal Dose

| | Standard Erythemal Dose | |
|---|---|---|
| Skin Type | (SED) adjust | STF |
| 1 | 3 | 1.07 |
| 2 | 3.2 | 1.00 |
| 3 | 4 | 0.80 |
| 4 | 5.25 | 0.61 |
| 5 | 7.5 | 0.43 |
| 6 | 13 | 0.25 |

A sun exposure factor is shown in Table 9.

TABLE 9
Sun exposure factor

| Sun Exposure | Variable | UNITS |
|---|---|---|
| % Body | BOD | % |
| Daily Exposure Time | DET | Min |
| Season | SEA | Date |
| Latitude | LAT | Number |
| Sunblock | SB | YES/NO |
| SPF | SPF | Number |

Estimate of Vitamin D Intake Needed

An estimate of the intake of vitamin D needed to raise blood level to a target amount was determined. A steady-state condition can be achieved wherein after taking the daily amount, a long term steady state may be achieved. This is in contrast to the “loading dose” and “maintenance dose” treatment plans which utilize a higher dose to raise from deficiency status to sufficiency, and then maintain at a daily utilization rate.

IU/day on the basis of weight was determined. Adjustments for age were made on the basis of the Age Factor (AF) to adjust the dose downward based at 50% of recommended dose at age 70 or greater. This accounts for lowered metabolism of D3 for age, along with the increased requirement of vitamin D3. The following equations can be used to calculate and process data relating to vitamin D3 formation.

SVD(Standard Vitamin D3 Dose)=SED/day*ASCF. Eq. 1

SED(Standard Erythemal Dose)=time+skin exposure+seasonal+latitude.

SED is an entry in the sun conversion for vitamin D. Using the skin type information, amount of skin exposed, and SED the amount of vitamin D made on average each day is determined. This is an input value.

VDD(Vitamin D dose)=SVD*GCF(Seasonal Geometric Conversion Factor). Eq. 2

Solar Produced=Vitamin D3 made per day in sunshine (IU/day)=VDD*(4900 IU for Skin Type 2, see Table 3)*STF*PBE*AF. Eq. 3

STF=Skin Type Factor. Eq. 4

PBE=Percent body exposure. Eq. 5

A percent body exposure is shown in Table 10.

TABLE 10
Percent Body Exposure.
Percent Body Exposure (PBE)

Age (Years)

| Exposure (%) | 0-5 | 10 | 15 | ≧22 |
|---|---|---|---|---|
| Half of head (face) | 7.8 | 5.5 | 4.5 | 3.5 |
| Half of neck (front) | 1 | 1 | 1 | 1 |
| Hands (front and back) | 5 | 5 | 5 | 5 |
| Lower arms | 6 | 6 | 6 | 6 |
| Lower legs | 10 | 12 | 13 | 14 |
| Half of upper arms | 4 | 4 | 4 | 4 |
| Half of upper legs | 7 | 8.5 | 9 | 9.5 |

Total

| | | | | |
|---|---|---|---|---|
| Winter | 13.8 | 11.5 | 10.5 | 9.5 |
| Spring/Fall | 30 | 29.5 | 29.5 | 15.5 |
| Summer | 40.8 | 42 | 43.5 | 33.5 |

For Summer only

| | | | | |
|---|---|---|---|---|
| Upper arms | 8 | 8 | 8 | 8 |
| Upper legs | 14 | 17 | 18 | 19 |
| Trunk | 26 | 26 | 26 | 26 |
| Feet | 7 | 7 | 7 | 7 |
| Bathing Suit/Diaper | 85.6 | 88.5 | 89.5 | 90.5 |

AF=Age Factor. Eq. 6

Convert the factors from the variables that control solar UV production.

Total Vitamin D Required.

Total Amount(IU)=Input[Solar Produced+Diet+Supplementation Factor]−Output[Daily Utilization Rate(DUR)]. Eq. 7

The Supplementation is the amount an individual takes via daily vitamin or supplements (outside of food and sunlight). This is asked to get a baseline level of vitamin D3 a person is taking. It is obtained as an average IU of D3 per day.

Diet input is a summation of the daily intake, based on the serving size. In the questionnaire, individuals are asked to estimate their average daily intake of the these foods, which have the most naturally occurring (or fortified) vitamin D3 content.

A diet input is shown in Table 11.

TABLE 11
Diet input

| | | | Vitamin | |
|---|---|---|---|---|
| | | | D per | |
| Food | Serving Size | | Serving | Units |
| milk | 1 | cup | 98 | IU |
| herring | 3 | ounces | 1775 | IU |
| salmon | 3 | ounces | 238 | IU |
| tuna | 3 | ounces | 136 | IU |
| sardines | 1 | ounce | 77 | IU |
| raisin bran cereal | 0.75 | cup | 42 | IU |
| pork | 1 | ounce | 31 | IU |
| egg yolk | 1 | | 25 | IU |
| Spinach | 0.5 | cup | 90 | IU |
| green leafy | 0.5 | cup | 50 | IU |
| vegetables | | | | |

Metabolic Utilization Factor or Rate

k=f(Age(Adjustor)+Sex(Adjustor)+Weight(Adjustor)+Metabolic(Adjustor)). Eq. 8

### Example 5

### Vitamin D Deficiency Questionnaire

1. City/Town:

2. State/Province/Region:

3. Country

4. Date of birth

5. Gender: M or F

6. Weight

7. Height

8. If Female: a. Currently pregnant?

Vitamin D Specific Questions:

9. Skin Type

10. Diet

a. How many servings per day, on average, do you have of the following foods?

i. Fish

ii. Eggs

11. Supplements

a. Accounting for all dietary supplements, how many international units (IU) of vitamin D3 do you currently take daily?

b. How long have you been taking this amount?

12. Sun Exposure

a. Do you use sunscreen regularly when outdoors between 10:00 AM and 2:00 PM (the most intense sunny period of the day).

b. If yes, what SPF?

c. How frequently do you use it: more than half the time, or less than half the time?

d. Do you use tanning equipment regularly?

i. If yes: how long? How many times per week?

e. How many hours of sun do you get on average each day between 10:00 AM and 2:00 PM?

f. How many hours of sun do you get on average each day between 2:00 AM and 5:00 PM?

g. How many hours of sun do you get on average each day after 5:00 PM?

h. On average, how much skin exposure do you get during your typical sun exposure daily (not counting sun-bathing)

(i). Face and hands only?

(ii). Face, hands, and arms?

(iii). Face, hands, arms, and feet?

(iv). Face, hands, arms, feet and legs?

(v). Face, hands, arms, legs, and back or belly?

i. How frequently do you sunbathe in a bathing suit during the summer, between 10:00 AM and 2:00 PM.

i. Daily

ii. 1-2 per week

iii. 3 or more times per week

iv. Never.

Vitamin D Deficiency Questionnaire

Accounting for all Dietary Supplements (Multivitamins, soft-gels, powdered supplements, etc.), how many international units (IU) of vitamin D do you currently take daily? (Do not include food sources here).

Skin Type

Skin Description

Reaction to Sun Exposure

I. Very pale or ruddy, Rarely tans Frequently sunburns

II. Pale or light-toned, Lightly tans Usually sunburns

III. Olive, Moderately tans Occasionally sunburns

IV. Light brown, Easily tans Seldom sunburns

V. Brown, Darkly tans Rarely sunburns

VI. Dark brown, Never sunburns

How many hours of sun do you get on average each week tanning? (Sunbathing or tanning booth).

Please exclude any time spent tanning for the next two questions:

How many hours of sun do you get on average each week between 10:00 AM and 2:00 PM?

How many hours of sun do you get on average each week between 2:00 PM and 10:00 AM?

On what parts of the body do you get sun exposure during a typical day? (not counting sunbathing)

Face and hands only

Face, hands, and arms

Face, hands, arms, and legs

Face, hands, arms, legs and feet

Face, hands, arms, legs, and back or belly

Do you go on sunny vacations for more than one week during the winter for sunbathing?

Choose the sunshine lifestyle that most resembles you:

You seldom leave the house.

You get slight sun exposure throughout the week.

You are moderately active with outdoor activities a couple of days of the week.

You are very active with outdoor activities most days of the week.

You are outside for a majority of the entire week.

Approximately how many servings of each of the following do you average each week?

Food Type

Serving Size

Weekly Servings

Beef, variety meats and by-products, liver, cooked, pan-fried

Salmon, Tuna, Halibut, Swordfish, Herring, Sardines, Mackerel

Pork

Egg (whole)

Approximately how many servings of each of the following do you average each week?

Milk

Processed cheese (American)

Milk based foods (puddings, yogurt, creams)

Fortified cereals

Mushrooms

Loading Treatment Plan

Variable Vitamin D Regimens.

Control Regimens: Loading Phase and Maintenance Phase.

Use a loading phase algorithm that controls the input based on a delta (difference) between the starting level and target level. If the delta is larger use a higher dose initially. Assume a 4 month equilibration phase to achieve steady state. Once the steady state level is achieved transition the control regimen to an equivalent daily utilization rate estimate. For example, if the DUR is 3000 IU, then use a 3000 IU average. Continue adaptive control offsets to account for seasonal variability in sunlight.

Using the following equation:

Y=Y(0)+a(1−ê(−bX))+cX

Where:

Y=serum 25(OH)D at steady state dosing of vitamin D3;

X=vitamin D3 dose (1,000's IU/d).

(i) The zero dose value (initial baseline prior to additional supplementation) of 25(OH)D: Y(0).

(ii) Expression describing the saturable exponential component relating to hepatic 25-hydroxylation: a(1−ê(−bX)).

(iii) a linear term relating to zero-order kinetics for 25-hydroxylase: cX.

Additionally:

a=The 25(OH)D increment at maximum saturation of the hepatic 25-hydroxylase.

b=The rate constant of the process.

c=The coefficient of the linear rise in serum 25(OH)D.

Based on published empirical clinical data of 3,667 participants, the equation is:

Y=32.9+32.7(1−ê(−0.1879×))+1.545X

Solving for X allows an estimate of the dose level to achieve a target blood level. Substitute Y(0) with the actual blood estimate at time zero.

Set Vitamin D target range for subject. Manage the preconfigured daily strengths of Vitamin D supplement (1500, 3000, 6000, and 9000 IU D3) or other amount, or configure daily supplement into single tablet of 750, 1500, 3000, or 4500 IU per day.

Process for Providing Healthcare.

The steps include: receiving input relating to a patient into a personalization processor, the input comprising one or more bioindicator levels and one or more personal indicator communications; operating the personalization processor for determining a patient personal assessment, wherein the personalization processor assigns relational impact factors to the input and combines the input, thereby forming the patient personal assessment; operating a differentiator processor for receiving information comprising normal and disease states, and for determining a diagnosis or prognosis for the patient by determining differences between the patient personal assessment and the normal and disease states; displaying a visualization of the patient personal assessment, the normal and disease states, and the diagnosis or prognosis.

Step 1: Scoring defaults to type (our currently configured strengths) The strength can be adjusted to any value and the output will represent a regimen of tablets or softgels (or injection) necessary to deliver the appropriate amount of vitamin D3):

Step 2: Estimate Current Intake:

GetSED (sunshineLifeStyle);

GetASCF (latitude, date);

GetGCF (latitude, date);

GetAF (age);

GetBaseAveragePBE (date, sunshineLifeStyle, percentageSPF);

GetSTF (skinType);

Calculate SVD=SED/day×ASCF.

SED*ASCF;

VDD=SVD*GCF

VDD=SVD*GCF;

Vitamin D3 (IU/day)=VDD×((4900 IU for Skin Type II)×STF)×PBE×AF.

VitaminDCurrent=retVal.VDD*(4900*retVal.STF)*retVal.PBE*AF+dietarySupplement;

Step 3: Get Desired Amount by Body Weight;

Step 4: Determine Deficit.

Step 5: Determine Daily recommendations based upon deficit and upon the desired recommendation types of Single or Multiple pill and dosing regimen (e.g. daily, other day, weekly)

Step 6: Determine D Score, daily average divided by daily desired as a percentage.

Step 7: Determine estimated ng/mL: A correlative relationship between reported blood levels and DScore. Estimate is (0.734*dScore)+7.4127−(0.0017*Math.Pow(dScore, 2)).

Operation of processor. Time data is a sequential series starting from the current date. Lookup tables are used for seasonal information. The latitude is obtained from the subject zip code. Additional latitude information can be provided by the subject for travel and vacation.

Subject scoring begins on the day that the questionnaire communications are received. Scoring is calculated for 365 days forward under the treatment plan, in 30 day intervals if supplementation is provided monthly. Latitude and season information is used to modify the lookup so that a maximal and minimal value are found at the summer solstice and winter solstice, respectively.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described herein.

All publications and patents and literature specifically mentioned herein are incorporated by reference for all purposes. Nothing herein is to be construed as an admission that the invention is not entitled to antedate such disclosure by virtue of prior invention.

It is understood that this invention is not limited to the particular methodology, protocols, materials, and reagents described, as these may vary. It is also to be understood that the terminology used herein is for the purpose of describing particular embodiments only, and is not intended to limit the scope of the present invention which will be encompassed by the appended claims.

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprises,” “comprising”, “containing,” “including”, and “having” can be used interchangeably.

Without further elaboration, it is believed that one skilled in the art can, based on the above description, utilize the present invention to its fullest extent. The following specific embodiments are, therefore, to be construed as merely illustrative, and not limitative of the remainder of the disclosure in any way whatsoever.

All of the features disclosed in this specification may be combined in any combination. Each feature disclosed in this specification may be replaced by an alternative feature serving the same, equivalent, or similar purpose.

What is claimed is:

1. A method for providing healthcare, the method comprising:
receiving input relating to a patient into a personalization processor, the input comprising one or more bioindicator levels and one or more personal indicator communications;
operating the personalization processor for determining a patient personal assessment, wherein the personalization processor assigns relational impact factors to the input and combines the input, thereby forming the patient personal assessment;
operating a differentiator processor for receiving information comprising normal and disease states, and for determining a diagnosis or prognosis for the patient by determining differences between the patient personal assessment and the normal and disease states;
displaying a visualization of the patient personal assessment, the normal and disease states, and the diagnosis or prognosis.

2. The method of claim 1, further comprising operating a treatment processor for generating a treatment and/or wellness plan based on the diagnosis or prognosis, and displaying a visualization of the treatment and/or wellness plan.

3. The method of claim 1, wherein the disease is vitamin deficiency or vitamin D deficiency.

4. The method of claim 1, wherein the bioindicators are genomic, proteomic, or clinical.

5. The method of claim 1, wherein the personal indicators are habitual, corporeal, geographical, temporal, seasonal, or physical.

6. The method of claim 1, wherein the patient personal assessment is based on the personal indicator communications alone without any biomarker information.

7. The method of claim 1, wherein the relational impact factors include skin type factor, percent body exposure factor, age factor, diet factor, metabolic utilization factor, action spectrum conversion factor, and supplementation factor.

8. The method of claim 1, wherein the differences between the patient personal assessment and the normal and disease patient states are determined by one or more of bioindicator T-scores, bioindicator Z-scores, and Hamming distances based on patient personal indicator communications, and combinations thereof.

9. The method of claim 1, wherein the differences between the patient personal assessment and the normal and disease patient states are determined by plasma 25(OH)D level.

10. The method of claim 2, wherein the treatment and/or wellness plan is determined by one or more methods selected from ADME analysis, regression analysis, residual error prediction, and principal component analysis.

11. The method of claim 2, wherein the treatment and/or wellness plan comprises providing a pharmaceutical, a nutraceutical, or a nutritional supplement.

12. A healthcare device for providing personalized patient wellness healthcare, the device comprising:
a portal for communicating input among patients, providers and laboratories;
a personalization processor configured for receiving the input, wherein the input comprises one or more bioindicator levels and one or more personal indicator communications, and wherein the personalization processor is configured for assigning relational impact factors to the input, thereby providing a patient personal assessment;
a differentiator processor for receiving information comprising normal and disease states, and for determining a diagnosis or prognosis for the patient by determining differences between the patient personal assessment and the normal and disease states; and
a display configured for providing a visualization of the patient personal assessment, the normal and disease states, and the diagnosis or prognosis.

13. The device of claim 12, wherein the disease states include vitamin deficiency and vitamin D deficiency.

14. The device of claim 12, wherein the differences between the patient personal assessment and the normal and disease states include differences in plasma 25(OH)D level.

15. The device of claim 12, wherein the patient personalization processor or differentiator processor is a smartphone, a personal or laptop computer, a tablet computer, or an internet portal, an internet application, or a cloud processor.

16. A kiosk comprising the device of claim 12, wherein the kiosk is configured for the patient viewing the visualization and receiving information for a product relating to the disease state.

17. The kiosk of claim 16, wherein the kiosk dispenses the product to the patient.

18. A non-transitory computer-readable medium having stored therein instructions for carrying out the steps of a method for providing healthcare, the method comprising:
receiving input relating to a patient into a personalization processor, the input comprising one or more bioindicator levels and one or more personal indicator communications;
operating the personalization processor for determining a patient personal assessment, wherein the personalization processor assigns relational impact factors to the input and combines the input, thereby forming the patient personal assessment;
operating a differentiator processor for receiving information comprising normal and disease states, and for determining a diagnosis or prognosis for the patient by determining differences between the patient personal assessment and the normal and disease states;
displaying a visualization of the patient personal assessment, the normal and disease states, and the diagnosis or prognosis.

19. The non-transitory computer-readable medium of claim 18, the method further comprising operating a treatment processor for generating a treatment and/or wellness plan based on the diagnosis or prognosis, and displaying a visualization of the treatment and/or wellness plan.

20. The non-transitory computer-readable medium of claim 18, wherein the disease is vitamin deficiency or vitamin D deficiency.
